(19) United States
(12) Patent Application Publication
(10) Pub. No.: US 2013/0258144 A1
(43) Pub. Date: Oct. 3, 2013

(54) SYSTEM, APPARATUS AND METHOD FOR DARK CURRENT CORRECTION

(71) Applicants: Gang Chen, San Jose, CA (US); Duli Mao, Sunnyvale, CA (US); Hsin-Chih Tai, San Jose, CA (US); Howard E. Rhodes, San Martin, CA (US)

(72) Inventors: Gang Chen, San Jose, CA (US); Duli Mao, Sunnyvale, CA (US); Hsin-Chih Tai, San Jose, CA (US); Howard E. Rhodes, San Martin, CA (US)

(73) Assignee: OMNIVISION TECHNOLOGIES, INC., Santa Clara, CA (US)

(21) Appl. No.: 13/432,958

(22) Filed: Mar. 28, 2012

(51) Int. Cl. H04N 9/64

(52) U.S. Cl. 348/243; 348/E05.079

(57) ABSTRACT

Embodiments of the invention describe a system, apparatus and method for obtaining black reference pixels for dark current correction processing are described herein. Embodiments of the invention capture image signal data via a plurality of pixel cells of a pixel unit of an image device, wherein capturing image signal data involves establishing a first state of exposing incident light on each pixel of the pixel unit and a second state of shielding incident light from one or more pixels of the pixel unit via a shutter unit disposed over the pixel unit. Image signal data from each pixel of the pixel unit captured during the first state and the second state is read, and scene image data is created by combining a subset of image signal data captured during the first state with a dark current component including a subset of image signal data captured during the second state.

### TECHNICAL FIELD

This disclosure relates generally to image capture devices, and in particular but not exclusively, relates to dark current correction processing for image capture devices.

### BACKGROUND INFORMATION

Complementary metal-oxide-semiconductor (“CMOS”) image sensors (“CIS”) may generate inaccurate image data due to dark current in the pixels themselves and variation in the level of dark current from pixel to pixel. Each pixel of a CIS array provides an output voltage that varies as a function of the light incident on the pixel. Unfortunately, dark currents add to the output voltages and degrade the picture provided by the imaging system.

The analog voltage associated with “true” black may be obtained by reading “black reference pixels.” In prior art solutions, black reference pixels are separate structures typically arrayed immediately next to an active image array. The black reference pixels are used to generate a low count value or a user specified set point value that will typically be displayed as black.

FIG. 1 is an illustration of a prior art imaging system that utilizes a dark pixel array as black reference pixels. Imaging system 100 includes imaging pixel array 105, black reference pixel array 107, readout circuitry 110, function logic 115, and control circuitry 120. Pixel array 105 is shown to be a two-dimensional (“2D”) array of imaging sensor pixels (e.g., AP1, AP2 . . . , APn) and black reference pixel array 107 is shown to be a separate array of light shielded pixels (e.g., BP0, BP1 . . . BP9). The black reference signals generated by black reference pixel array 107 are used to adjust, offset, or otherwise calibrate the black level set point of the imaging sensors thereby accounting for variations in dark current. However, the need for a separate imaging component to generate said black reference signals increases the size of imaging system 100.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified. The drawings are not necessarily to scale, emphasis instead being placed upon illustrating the principles being described.

FIG. 1 is an illustration of a prior art imaging system that utilizes a dark pixel array as black reference pixels.

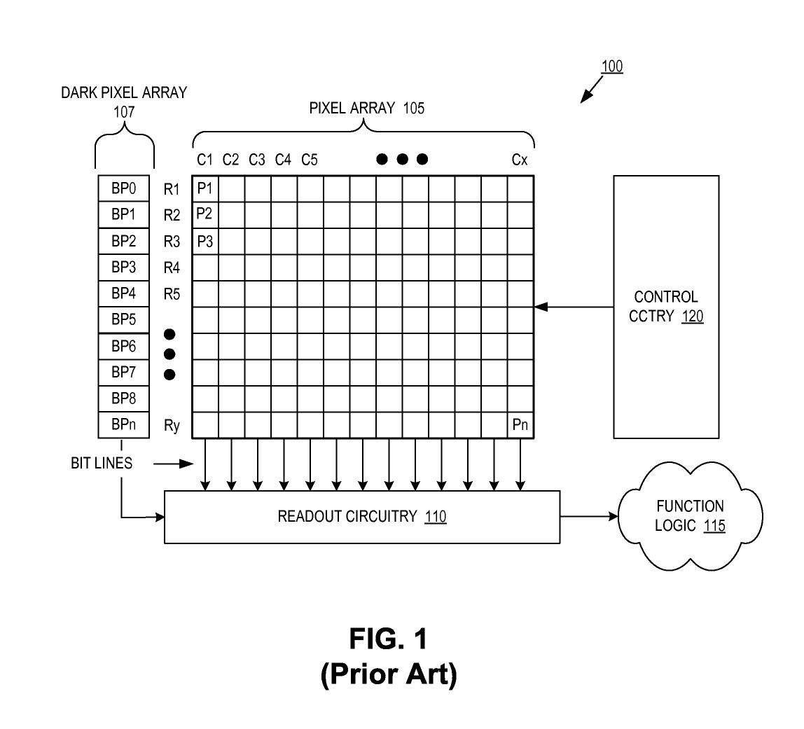

FIG. 2 is a functional block diagram illustrating an imaging system according to an embodiment of the invention.

FIG. 3 illustrates a conventional frontside illuminated CMOS imaging pixel according to an embodiment of the invention.

FIG. 4 is a hybrid cross sectional/circuit illustration of a backside illuminated CMOS imaging pixel according to an embodiment of the invention.

FIG. 5 is an illustration of an image sensor and a shutter assembly according to an embodiment of the invention.

FIG. 6A-FIG. 6C are a cross-section views of a camera assembly according to an embodiment of the invention.

FIG. 7 is a flow diagram of a process for acquiring black reference pixels for dark current correction processing according to an embodiment of the invention

Descriptions of certain details and implementations follow, including a description of the figures, which may depict some or all of the embodiments described below, as well as discussing other potential embodiments or implementations of the inventive concepts presented herein. An overview of embodiments of the invention is provided below, followed by a more detailed description with reference to the drawings.

### DETAILED DESCRIPTION

Embodiments of an apparatus, system and method for obtaining black reference pixels for dark current correction processing for image capture devices are described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

References throughout this specification to “one embodiment” or “an embodiment” means that a particular feature, structure, process, block or characteristic described in connection with an embodiment included in at least one embodiment of the present invention. Thus, the appearance of the phrases “in one embodiment” or “in an embodiment” in various places throughout this specification does not necessarily mean that the phrases all refer to the same embodiment. The particular features, structures or characteristics may be combined with any suitable manner in one or more embodiments.

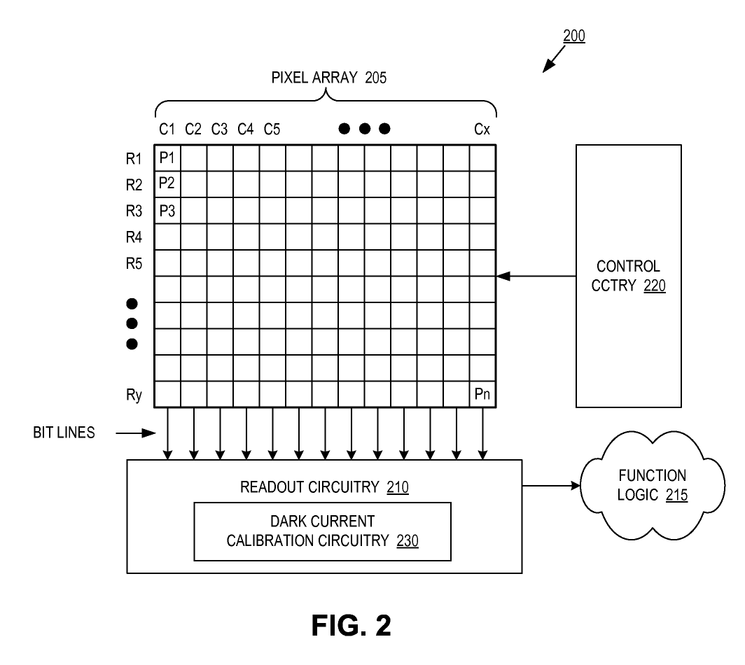

FIG. 2 is a functional block diagram illustrating an imaging system according to an embodiment of the invention. The illustrated embodiment imaging system 200 includes pixel array 205, readout circuitry 210, function logic 215 and control circuitry 220 having dark current calibration circuitry 230.

Pixel array 205 is a two-dimensional (2D) array of imaging sensor cells or pixel cells (e.g., pixels P1, P2, . . . , Pn). In one embodiment, each pixel cell is a complementary metal-oxide-semiconductor (CMOS) imaging sensor (CIS). Pixel array 205 may be implemented as a front-side illuminated (FSI) image sensor or a backside illuminated (BSI) image sensor. As illustrated, each pixel cell is arranged into a row (e.g., rows R1 to Ry) and a column (e.g., column C1 to Cx) to acquire image data of a person, place or object, which can then be used to render an image of the person, place or object. As described in further detail below, pixel array 205 utilizes shutter assembly (e.g., a metal layer or liquid crystal shutter assembly) to generate black reference signals used for dark current correction and/or fixed pattern noise reduction.

After each pixel has acquired its image data or image charge, the image data is readout by readout circuitry 210 and transferred to function logic 215. Readout circuitry 210 may include column amplification circuitry, analog-to-digital (ADC) conversion circuitry, or otherwise. Function logic 215 may simply store the image data or even manipulate the image data by applying post image effects (e.g., crop, rotate, remove red eye, adjust brightness, adjust contrast or otherwise). In one embodiment, readout circuitry 210 may readout a row of image data at a time along readout column lines or may readout the image data using a variety of other techniques (not illustrated), such as serial readout, column readout along readout row lines, or a full parallel readout of all pixels simultaneously. It should be appreciated that the designation of a line of pixel cells within pixel array 205 as either a row or a column is arbitrary and one of rotational perspective. As such, the use of the terms “row” and “column” are intended merely to differentiate the two axes relative to each other.

Control circuitry 220 is coupled to pixel array 205 and includes logic and driver circuitry for controlling operational characteristics of pixel array 205. For example, reset, row select, and transfer signals may be generated by control circuitry 220. Control circuitry 220 may include a row driver, as well as other control logic.

In this embodiment, dark current calibration circuitry 230 receives black reference signals generated by pixel array 205, which ultimately is used to adjust, offset, or otherwise calibrate the black level set point of the imaging sensors (i.e., APS) thereby accounting for variations in dark current. In the illustrated embodiment, because many of the influences on the black level set point of each active pixel have localized variations, it may be desirable to distribute the black reference pixels to better account for these localized variations. Some of these localized influences may include temperature, parasitic capacitances, structural design differences, lattice structure defects, and the like. Consequently, pixel array 205 may capture black reference signals in a variety of different patterns (e.g., around the perimeter of the array, in the corners of the array, in one or more columns, in one or more rows, in one or more clusters, in a checkerboard pattern, in an irregular distribution, or otherwise).

During operation each active pixel acquires image data or image charge in two states—light and dark. For example, in embodiments utilizing a liquid crystal shutter assembly, said light state corresponds to image data acquired when said shutter is in a transparent state, while said dark state corresponds to image data acquired when said shutter is in an opaque state. Said image data is readout by readout circuitry 210 and transferred to function logic 215. In one embodiment, dark current calibration of the image data is performed within readout circuitry 210 prior to outputting the image data off-chip. In an alternative embodiment, the black reference signals are transferred off-chip with the uncorrected image data into system software or off-chip hardware calibration logic. In one of these alternative embodiments, level calibration is performed off-chip using post-image processing in system software with reference to the scaled black reference signals. In yet another alternative embodiment, temperature signals (from temperature sensors disposed on pixel array die 201) and black reference signals are readout along with the image data and post-processing used to both temperature scale the black reference signals and level correct the image data using the black reference signals.

Readout circuitry 210 may include amplification circuitry, analog-to-digital conversion circuitry, or otherwise. In the illustrated embodiment, readout circuitry 210 includes black level calibration circuitry 225 for adjusting or calibrating a black level set point of each active pixel. In one embodiment, said black level set point is the signal level output from each active pixel at which the pixel is deemed to have captured a “true” black image. Dark current calibration circuitry 230 may scale (e.g., offset, linearly scale, nonlinearly scale, or some combination thereof) the voltage output for each of the active pixels with reference to the output value from its corresponding black reference signal.

Although FIG. 2 illustrates dark current calibration circuitry 230 as internal to readout circuitry 210, it should be appreciated that black level calibration circuitry 230 may be integrated into other functional blocks on the same die as pixel array 205. For example, dark current calibration circuitry 230 may be implemented as application specific circuitry for executing embedded logic or a general purpose processor executing firmware embedded elsewhere on the die. Alternatively, the functions performed by dark current calibration circuitry 230 may be implemented as software logic within function logic 215 and executed off-die. In one embodiment, just the firmware/software logic may be stored off-die and imported into dark current calibration circuitry 230 at startup.

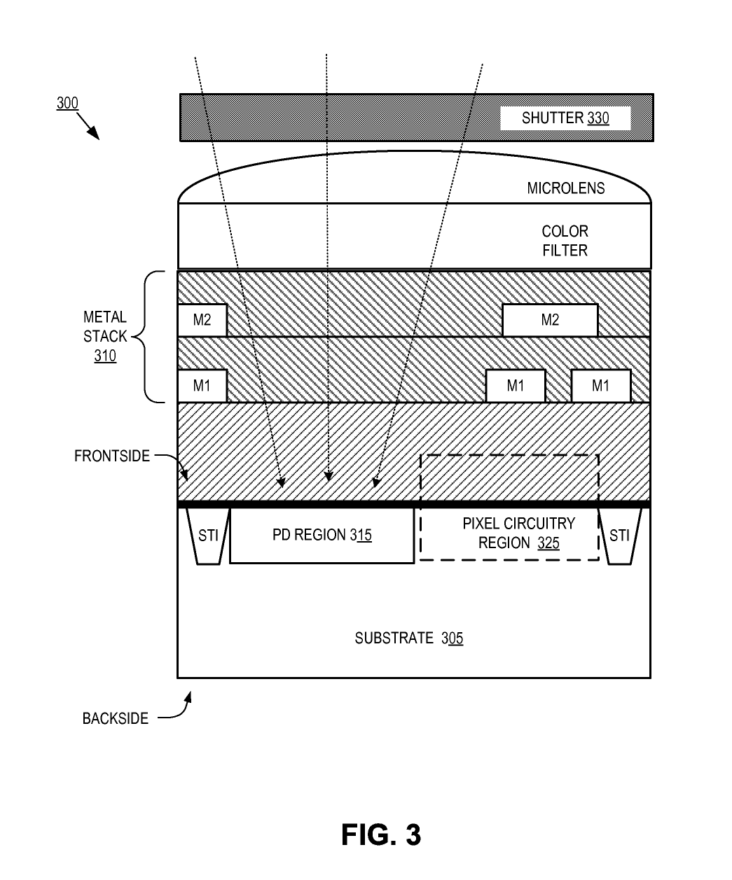

FIG. 3 illustrates a conventional FSI CMOS imaging pixel according to an embodiment of the invention. Imaging pixel 300 is one possible implementation of pixels P1 to Pn within pixel array 205 of FIG. 2. The frontside of imaging pixel 300 is the side of substrate 305 upon which the pixel circuitry is disposed and over which metal stack 310 for redistributing signals is formed. The metal layers (e.g., metal layer M1 and M2) are patterned in such a manner as to create an optical passage through which light incident on the frontside of imaging pixel 300 can reach the photosensitive or photodiode (“PD”) region 315. The frontside may further include a color filter layer to implement a color sensor and a microlens to focus the light onto PD region 315.

Imaging pixel 300 includes pixel circuitry disposed within pixel circuitry region 325 adjacent to PD region 315. This pixel circuitry provides a variety of functionality for regular operation of imaging pixel 300. For example, pixel circuitry region 325 may include circuitry to commence acquisition of an image charge within PD region 315, to reset the image charge accumulated within PD region 315 to ready imaging pixel 300 for the next image, or to transfer out the image data acquired by imaging pixel 300.

In this embodiment, pixel 300 is shown to utilize shutter assembly 330 to capture image data or image charges in light and dark states. For example, in embodiments where shutter assembly 330 comprises a liquid crystal material, said light state corresponds to image data acquired when shutter assembly 330 is in a transparent state, while said dark state corresponds to image data acquired when shutter assembly 330 is in an opaque state. Image data captured in said dark state may be used in dark current calibration processes as described herein.

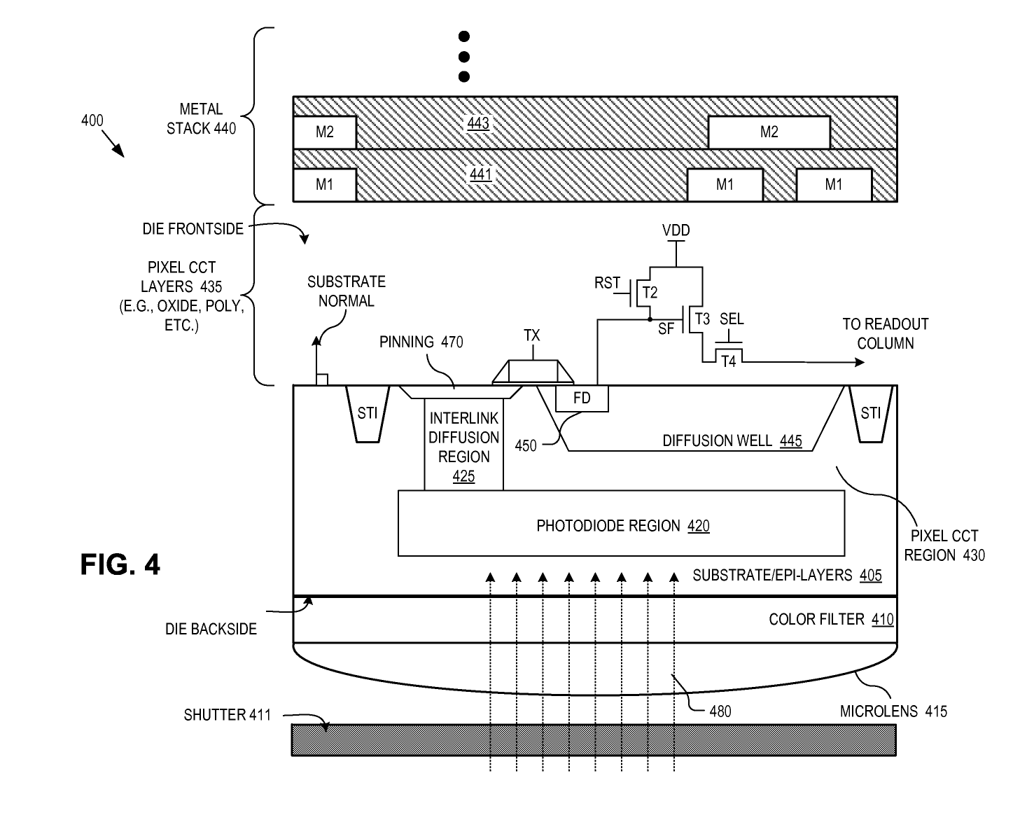

FIG. 4 is a hybrid cross sectional/circuit illustration of a BSI CMOS imaging pixel according to an embodiment of the invention. Imaging pixel 400 is one possible implementation of pixels P1 to Pn within pixel array 205 of FIG. 2. The illustrated embodiment of imaging pixel 400 includes a substrate 405, a color filter 410, a microlens 415, a PD region 420, an interlinking diffusion region 425, a pixel circuitry region 430, pixel circuitry layers 435, and a metal stack 440. The illustrated embodiment of pixel circuitry region 430 includes a pixel (e.g., a 4T pixel or any functional equivalent), as well as other circuitry not shown (e.g., gain circuitry, ADC circuitry, gamma control circuitry, exposure control circuitry, etc.), disposed over a diffusion well 445. A floating diffusion 450 is disposed within diffusion well 445 and coupled between transfer transistor T1 and the gate of SF transistor T3. The illustrated embodiment of metal stack 440 includes two metal layers M1 and M2 separated by intermetal dielectric layers 441 and 443. Although FIG. 4 illustrates only a two layer metal stack, metal stack 440 may include more or less layers for routing signals over the frontside of pixel array 205. In one embodiment, a passivation or pinning layer 470 is disposed over interlinking diffusion region 425. Finally, shallow trench isolations (“STI”) isolate imaging pixel 400 from adjacent pixels (not illustrated).

As illustrated, imaging pixel 400 is photosensitive to light 480 incident on the backside of its semiconductor die. By using a backside illuminated sensor, pixel circuitry region 430 can be positioned in an overlapping configuration with photodiode region 420. By inserting circuitry in close proximity to each PD region 420, circuit noise can be reduced and noise immunity improved due to shorter electrical interconnections between PD region 420 and the additional in-pixel circuitry. Furthermore, the backside illumination configuration provides greater flexibility to route signals over the frontside of host pixel array within metal stack 440 without interfering with light 480. In one embodiment, the shutter signal is routed within metal stack 440 to the pixels within said host pixel array.

In this embodiment, pixel 400 is shown to utilize shutter assembly 411 to capture image data or image charge in light and dark states. For example, in embodiments where shutter assembly 411 comprises a liquid crystal material, said light state corresponds to image data acquired when shutter assembly 411 is in a transparent state, while said dark state corresponds to image data acquired when shutter assembly 411 is in an opaque state. Image data captured in said dark state may be used in dark current calibration processes as described herein.

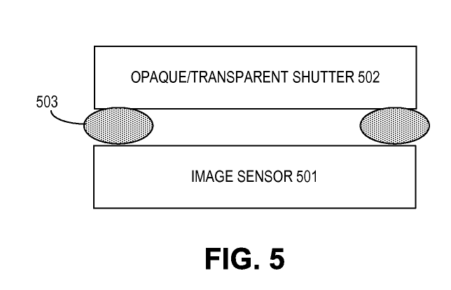

FIG. 5 is an illustration of an image sensor and a shutter assembly according to an embodiment of the invention. FIG. 5 shows a shutter 502, such as a liquid crystal shutter, affixed over image pickup element chip 501 by use of, for example, adhesive 503. There may be any number of other ways to position a shutter, such as a liquid crystal shutter, over the image pickup element chip between it and the object whose light is to be captured by image pickup element chip 501. The image pickup element chip 501 may comprised of a CMOS solid-state image pickup element containing a pixel circuit and a readout circuit and other circuits (e.g., as shown in FIG. 2). It may also include a circuit for controlling the shutter, but some embodiments such a circuit may be part of a higher level system module and not contained within the same silicon substrate as the image pickup element chip.

Shutter 502 is operable for establishing the state of light (i.e., an image light) incident to a pixel unit of image sensor 501 or the state of shielding the pixel unit from the light. Said shutter unit is illustrated in FIG. 5 as a liquid crystal shutter which is a transparent/opaque type liquid crystal shutter; in other embodiments said shutter unit may utilize a metal layer for shielding the pixel unit from the light. In this embodiment, shutter unit 502 is controlled to be transparent or opaque, respectively, under the control of a shutter control unit and coordinated with the pixel control unit on the image pickup element chip 501. The shutter construction and shutter control unit may allow pixel by pixel, line by line or simultaneous exposure of all pixels to incident light due to having its own array of controllable lines of transparency or opacity which are aligned to the image sensor chip pixel array lines.

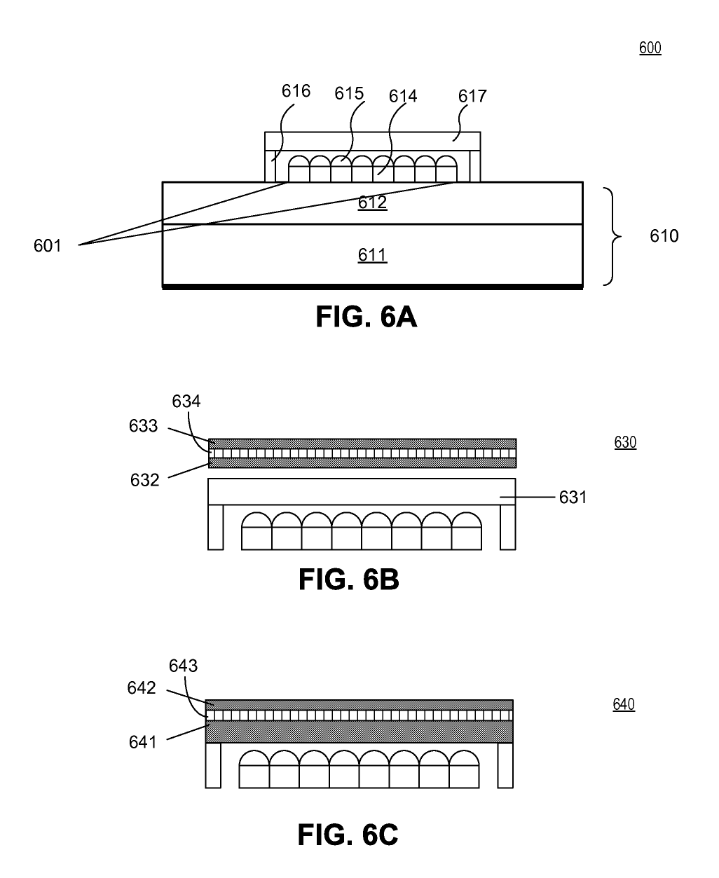

FIG. 6A-FIG. 6C are a cross-section views of a camera assembly according to an embodiment of the invention. In this embodiment, camera assembly 600 includes an array of imaging pixels. Each pixel of said array is formed from substrate 611 and metal stack 612. For example, each pixel of the array may have a PD region formed in substrate 611 that receives light that passes through metal stack 612, similar to FSI imaging pixel 300 shown in FIG. 3. In other embodiments, camera system 600 may comprise a BSI pixel array.

Each pixel of the FSI array may utilize a corresponding color filter 614 and microlens 615. Imaging system 610 further includes adhesive glue 616 and shutter assembly 617 disposed over said microlenses.

A shutter assembly may comprise an assembly as shown in FIG. 6B, placed above cover glass 631. In this example, shutter unit 630 is shown to comprise liquid crystal cell 634 disposed between transparent electrodes 632 and 633. Said transparent electrodes control the opacity of said liquid crystal cell. In other embodiments, a shutter assembly may comprise an assembly as shown in FIG. 6C. In this example, shutter unit 640 utilizes cover glass 641 as one side of liquid crystal cell 643, thereby eliminating the need for a transparent electrode other than electrode 642 as shown.

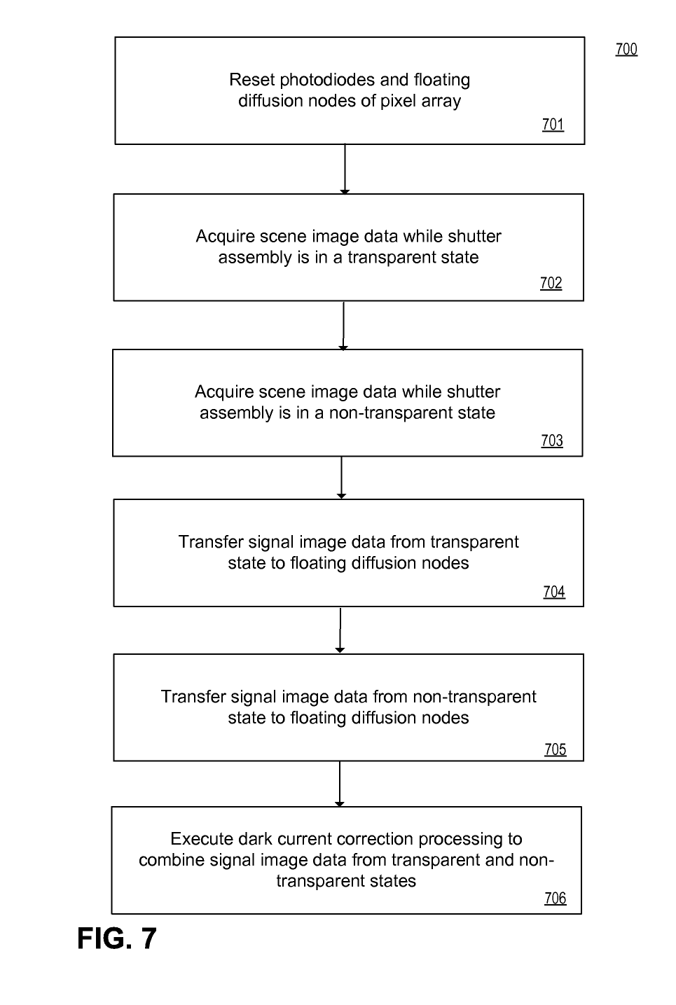

FIG. 7 is a flow diagram of a process for acquiring black reference pixels for dark current correction processing according to an embodiment of the invention. Flow diagrams as illustrated herein provide examples of sequences of various process actions. Although shown in a particular sequence or order, unless otherwise specified, the order of the actions can be modified. Thus, the illustrated implementations should be understood only as examples, and the illustrated processes can be performed in a different order, and some actions may be performed in parallel. Additionally, one or more actions can be omitted in various embodiments of the invention; thus, not all actions are required in every implementation. Other process flows are possible

Process 700 includes operations for resetting the photodiodes and floating diffusion nodes of a pixel array of an imaging system, 701. Once these elements are reset, image data is acquired while a shutter assembly of the pixel system is in a transparent state (i.e., light image data), 702, and a non-transparent state (i.e., dark image data), 703. It is important to note that in various embodiments of the invention, acquiring light and dark image data may be done in any order, and comprise acquiring light and dark image data any number of times—e.g., the states in which image are acquired may comprise light-dark, dark-light, dark-light-dark, light-dark-light, etc.

Light and dark image data is then transferred to floating diffusion nodes, shown as operations 704 and 705, respectively. In embodiments of the invention, the shutter unit may allow pixel by pixel, line by line or simultaneous exposure of all pixels to incident light due to having its own array of controllable lines of transparency or opacity which are aligned to image sensor chip pixel array lines; thus, the order of how light and dark image data is transferred to floating diffusion nodes may be dependent of the operation of the shutter unit.

Dark current correction processing is executed to combine signal image data captured from both the light and dark states, 706. Said processing utilizes signal image data captured from the dark state (i.e., when the shutter shields light for one or more pixels) as a faithful representation of the dark current component of the scene image data. The corresponding image signal data captured during the light state may be modified by a scaling factor and/or removed from the processed scene image data, in order to generate accurate dark current images and/or reduce fixed pattern noise. Thus, the scene image data resulting from said dark current correction processing comprises a subset of image signal data captured during the light state, and a dark current component including a subset of image signal data captured during the dark state.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize. For example, in one embodiment, RS transistor 610 may be omitted from the pixel cells. The omission of RS transistor 610 would not affect the operation of the pixel cells during ambient light detection mode. In one embodiment two or more photodiodes share the pixel circuitry of a pixel cell, such as reset transistor, source follower transistor or row select transistor.

Modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A solid-state image pickup apparatus, comprising:
a pixel unit comprising a plurality of pixels;
a shutter unit disposed over the pixel unit;
a pixel control unit for controlling the plurality of pixel cells of the pixel unit in response to receiving an image capture command, including establishing a first state of exposing incident light on each pixel of the pixel unit and a second state of shielding incident light from one or more pixels of the pixel unit via the shutter unit; and
a readout unit for:
reading image signal data from each pixel of the pixel unit captured during the first state and the second state; and
outputting scene image data comprising a subset of image signal data captured during the first state and a dark current component including a subset of image signal data captured during the second state.

2. The apparatus of claim 1, wherein the pixel unit comprises an array of complementary metal-oxide-semiconductor (CMOS) backside illuminated (BSI) pixels.

3. The apparatus of claim 1, wherein the pixel unit comprises an array of complementary metal-oxide-semiconductor (CMOS) frontside illuminated (FSI) pixels.

4. The apparatus of claim 1, wherein the shutter unit includes a metal layer for covering the pixels of the pixel unit.

5. The apparatus of claim 1, wherein the shutter unit comprises a liquid crystal shutter unit.

6. The apparatus of claim 5, wherein the liquid crystal shutter unit comprises:
a first and a second transparent electrode; and
a liquid crystal cell disposed between the transparent electrodes.

7. The apparatus of claim 5, wherein the liquid crystal shutter unit comprises:
a transparent electrode; and
a liquid crystal cell disposed between the transparent electrode and a cover glass assembly disposed over the pixel unit.

8. The apparatus of claim 1, wherein the signal data captured during the first state is captured subsequent to the signal data captured during the second state.

9. The apparatus of claim 1, wherein the signal data captured during the second state is captured subsequent to the signal data captured during the first state.

10. The apparatus of claim 1, the pixel unit further comprising:
a color filter layer covering the plurality of pixels; and a
an array of microlenses disposed over the color filter layer and aligned with the plurality of pixels.

11. A method comprising:
receiving an image capture command;
capturing image signal data via a plurality of pixel cells of a pixel unit in response to receiving the image capture command, wherein capturing image signal data includes establishing a first state of exposing incident light on each pixel of the pixel unit and a second state of shielding incident light from one or more pixels of the pixel unit via a shutter unit disposed over the pixel unit;
reading image signal data from each pixel of the pixel unit captured during the first state and the second state; and
outputting scene image data comprising a subset of image signal data captured during the first state and a dark current component including a subset of image signal data captured during the second state.

12. The method of claim 11, wherein the pixel unit comprises an array of complementary metal-oxide-semiconductor (CMOS) backside illuminated (BSI) pixels.

13. The method of claim 11, wherein the pixel unit comprises an array of complementary metal-oxide-semiconductor (CMOS) frontside illuminated (FSI) pixels.

14. The method of claim 11, wherein the shutter unit includes a metal layer for covering the pixels of the pixel unit.

15. The method of claim 11, wherein the shutter unit comprises a liquid crystal shutter unit.

16. The method of claim 15, wherein the liquid crystal shutter unit comprises:
a first and a second transparent electrode; and
a liquid crystal cell disposed between the transparent electrodes.

17. The method of claim 15, wherein the liquid crystal shutter unit comprises:
a transparent electrode; and
a liquid crystal cell disposed between the transparent electrode and a cover glass assembly disposed over the pixel unit.

18. The method of claim 11, wherein the signal data captured during the first state is captured subsequent to the signal data captured during the second state.

19. The method of claim 11, wherein the signal data captured during the second state is captured subsequent to the signal data captured during the first state.

20. The method of claim 11, the pixel unit further comprising:
a color filter layer covering the plurality of pixels; and a
an array of microlenses disposed over the color filter layer and aligned with the plurality of pixels.
